(19) United States
(12) Patent Application Publication
(10) Pub. No.: US 2026/0127232 A1
(43) Pub. Date: May 7, 2026

(54) MERGING GENERATIVE MODEL PROMPTS BASED ON CONTEXT

(71) Applicant: GOOGLE LLC, Mountain View, CA (US)

(72) Inventors: Matthew Sharifi, Kilchberg (CH); Victor Carbune, Zurich (CH)

(21) Appl. No.: 18/934,877

(22) Filed: Nov. 1, 2024

(51) Int. Cl. G06F 16/9532; H04N 21/45

(52) U.S. Cl. CPC G06F 16/9532; H04N 21/4532

(57) ABSTRACT

Implementations are described herein for accounting for preferences and/or attributes of multiple users and/or computing devices in a context that is shared between the multiple users and/or multiple computing devices and a generative model-powered automated assistant. Data indicative of preferences and/or attributes of user(s) and/or their computing device(s) can be assembled into “merged” input prompts, e.g., along with a natural language query issued by one of the users. The merged input prompts may then be processed using generative model(s) to generate output that is conditioned on the preferences and/or attributes of the user(s) and/or their computing device(s).

### BACKGROUND

Generative models such as unimodal or multimodal large language models (LLMs) can be used to process sequences of input tokens to generate sequences of output tokens. Generative models are applicable across a wide range of tasks. For example, generative models are increasingly being used to power automated assistants (also referred to as “virtual assistants” or “chatbots”), which enable humans (which are referred to as “users” when interacting with automated assistants) to participate in natural language dialogs with automated assistants. In many instances, an automated assistant powered by generative model(s) may act as a participant in context that is shared among multiple users. A shared context may be, for instance, a shared physical environment where co-present users can interact with a shared assistant device, a shared virtual environment such as a message exchange thread and/or video conference call, etc.

### SUMMARY

Implementations described herein relate to accounting for preferences and/or attributes of multiple users and/or computing devices in a context that is shared between the multiple users and a generative model. More particularly, but not exclusively, implementations are described herein for assembling data indicative of preferences and/or attributes of user(s) and/or their computing device(s) into “merged” input prompts, e.g., along with a natural language query issued by one of the users. The merged input prompts may then be processed using generative model(s) to generate output that is conditioned on the preferences and/or attributes of the user(s) and/or their computing device(s).

In various implementations, what will be referred to herein as “user prompts” may be determined/formulated for one or more users in a shared context. These user prompts may be used to condition generative model(s) to generate output that accounts for the user(s) preference(s) and/or attribute(s). For example, preferences and/or attributes of a user may, with user consent, be inferred from various electronic sources, such as explicit statement(s) from the user, past queries submitted to automated assistant(s), past search engine queries, digital files created or interacted with by the user, electronic correspondence (e.g., emails, text messages) sent and/or received by the user, social media posts of the user, web browsing history, past online bookings, past travel trajectories, etc. These preferences and/or attributes may be used to formulate a user prompt of the user. In some implementations, user prompts may be formulated as natural language statements, such as “I like jazz but let's avoid rock style” or “I like Chinese cuisine but try to eat vegetarian if at all possible, and I prefer public transit over driving or walking” In other implementations, user prompts may be formulated in other ways such as structured text (e.g., XML, JSON, etc.). In some implementations, a generative model such as an LLM or similar may be used to process data obtained from the various electronic sources to formulate a single user prompt that summarizes the user's preferences and/or attributes.

Similarly, in various implementations, what will be referred to herein as “device prompts” may be determined/formulated for one or more computing devices that are operated by one or more users in a shared context. These device prompts may include various attributes of the computing devices, such as user preferences for how the devices are used (e.g., “I prefer not to use this device for video playback”), one or more capabilities and/or states of the device (e.g., display or no display, muted or unmuted, volume level, amount of memory, display size, etc.), position coordinates of the device, and so forth. Like the user prompts, these device prompts may be formulated in some implementations as natural language, such as “I prefer not to use this device for video playback” or “this device is currently muted.” In other implementations, device prompts may be formulated in other ways such as structured text (e.g., XML, JSON, etc.). In some implementations, a generative model such as an LLM or similar may be used to process data obtained from various electronic sources (e.g., the device itself) to formulate a single device prompt that summarizes the device's attributes. In some implementations, device prompts can be inferred for various devices. For example, a device prompt for a particular device can be inferred based on the usage history of the particular device, such as which content a user typically consumes via that particular device and/or other details about the device and/or the content that the user typically consumes via that particular device.

Data indicative of one or more user prompt(s) and/or one or more device prompt(s) may be assembled into what will be referred to as a “merged input prompt,” e.g., along with various other data. This other data may include, for instance, a natural language query issued by a user to an automated assistant in a shared context. The merged input prompt may then be processed using generative model(s) to generate output that is conditioned based on the user and/or device prompt(s).

In various implementations, a first user in a shared context may issue a natural language query to an automated assistant. The natural language query may be typed or spoken. In the latter case, the spoken natural language query may be transcribed using speech-to-text (STT) processing, or data indicative of the audio waveform may be processed using a machine learning model trained to map audio waveforms directly to responsive actions (e.g., without performing STT).

A determination may then be made, based on signal(s) provided by computing device(s), that the first user is in a shared context with one or more other users. These signals may include, but are not limited to, a wireless signal (e.g., BLUETOOTH, WI-FI, NFC, cellular signal, etc.) generated by a mobile device carried by one or more of the users, an electronic calendar of one or more of the users, position coordinates of mobile devices carried by the users, contemporaneous detection of biometrics (e.g., voice recognition, facial recognition, etc.) of the users, and so forth.

User prompts may then be determined for at least some of the users in the shared context, as described previously. Additionally or alternatively, device prompts may be determined for at least some computing devices (or sensors thereof) operated by users in the shared context or otherwise available in the shared context (e.g., a shared standalone assistant-powered speaker). Data indicative of these user and/or device prompts may be assembled into a merged input prompt, e.g., along with data indicative of the natural language query. The merged input prompt may then be processed using generative model(s) to generate output that is conditioned on the user prompt(s) and/or device prompt(s), and that includes content (e.g., natural language, audio, video, etc.) that is responsive to the natural language query. The responsive content may then be output at one or more computing devices.

Assembling user prompts into the merged input prompt may increase data security because it avoids the need for the users to explicitly inform each other of preferences and/or attributes that may be sensitive and/or private. For instance, a user may have a preference or attribute that they would prefer to keep to themselves, such as “I am uncomfortable in crowded places,” “I prefer not to tip,” or “I am a member of X political party.” As another example, a computing device may have various security settings and/or hardware capabilities that should not be widely disseminated, e.g., to avoid raising security risks. By incorporating these preferences into user/device prompts, it is possible to condition generative model output to account for these preferences/attributes without other users being made aware of them. Even if the multiple users are permitted access to the merged input prompt, the individual user and/or device prompts may be expressed in tokens, which may not necessarily be human interpretable (e.g., because they are continuous embeddings).

In some implementations, output be curated as not to reveal the details of the user and/or device prompts used as input. For example, If user 1 and user 2 are watching a sports program and User 1 has a user prompt that indicates “User 1 does not like basketball”, the output can be a football game, which can be rendered without any indication that it was selected instead of a basketball game because of User 1's prompt. As another example, food orders can be curated to include multiple options that would be acceptable to a variety of users as to not reveal a food allergy or preference that a particular user may be sensitive about or otherwise not wish to be revealed.

Leveraging user and/or device prompts to condition generative model(s) to generate output that is tailored towards individual users and/or groups of users may result in output that is more informative and/or objectively useful to a greater number of users. This in turn may reduce the number of queries issued to a generative model-powered automated assistant. Because generative models may have hundreds of billions of parameters or more, reducing the number of issues queries may conserve considerable computational resources (e.g., memory, processor cycles), power, and/or time.

In addition, by leveraging preferences and/or attributes of multiple different users/devices to render a single generative model response, the response is tailored towards a larger audience. Consequently, the response may be objectively improved compared to generative model responses that are generated based solely on a single user's query/context. Moreover, merging user and/or device prompts for multiple users/devices may provide for an improved unified interface between a plurality of users and a single instance of an automated assistant in a shared context.

In some implementations, relative weights of the various user and/or device prompts may be determined based on various signals, such as relative proximities of users to a shared audio or vision sensor, and/or based on which of the users issued the natural language query. These weights may then be used in various ways to condition the generative model to generate output that reflects the relative weights.

In some implementations, the relative weights may be used to allocate different numbers of tokens of the merged input prompt to different user and/or device prompts. For instance, more tokens of the merged input prompt may be allocated to user (or device) prompt(s) that have greater weights; user (or device) prompts assigned lower weights may be allocated less tokens, which may involve truncation to a predetermined number of tokens. Additionally or alternatively, in some implementations, a generative model may be used to generate a summary of the user/device prompt subject to some target length constraint (e.g., number of tokens, number of words, number of sentences, number of clauses, etc.).

In other implementations, the weights may be used as and/or to determine relative priorities to be assigned to known preferences and/or attributes conveyed in the user/device prompts. These relative priorities may then be assembled into the merged input prompt to condition the generative model's output accordingly. For example, if two different users have conflicting food preferences, the user prompt of the user assigned a greater weight (e.g., because he/she issued the natural language query to the automated assistant) may have a higher priority assigned to their preference, which may result in the other user's preference being demoted or ignored.

In various implementations, the weights can be semantic descriptors and/or numeric representations of a relative priority with which particular user and/or device prompts will be treated. For example, a first user prompt can have a weight that has a semantic representation of “Treat user 1 prompt with high priority” and/or “Treat user 2 prompt with low priority”.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts an example process flow using various components from the example environment from FIG. 1, in accordance with various implementations.

FIG. 3 schematically depicts a flowchart demonstrating an example of how techniques described herein may be carried out.

FIGS. 4A, 4B, and 4C schematically depict an example of how techniques described herein may be implemented, in accordance with various implementations.

FIG. 5 schematically depicts a flowchart demonstrating an example of how techniques described herein may be carried out.

FIGS. 6A, 6B and 6C schematically depict an example of how techniques described herein may be implemented, in accordance with various implementations.

FIG. 7 schematically depicts an example architecture of a computer system.

### DETAILED DESCRIPTION

Some implementations described herein relate to utilizing generative models to power automated assistants (also referred to as “virtual assistants” or “chatbots”), which enable humans (which are referred to as “users” when interacting with automated assistants) to participate in natural language dialogs with automated assistants. For example, in some implementations, an automated assistant powered by generative model(s) may act as a participant in a context that is shared among multiple users. A shared context may be, for instance, a shared physical environment where co-present users can interact with a shared assistant device, a shared virtual environment such as a message exchange thread and/or video conference call, etc.

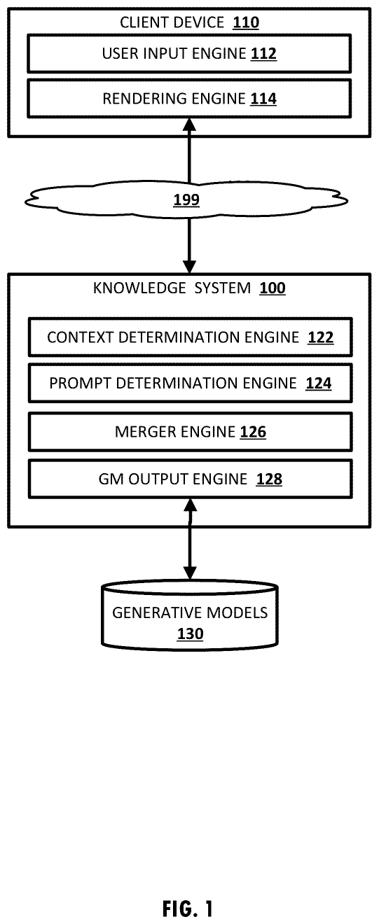

FIG. 1 is a block diagram illustrating components that can cooperate to carry out selected aspects of the present disclosure, in accordance with various implementations. The various components depicted in FIG. 1, particularly those components forming a knowledge system 100, may be implemented using any combination of hardware and software. The components of FIG. 1 are depicted as being communicatively coupled with each other via one or more networks 199, which may include one or more of personal area networks, local area networks, or wide area networks (e.g., the Internet). However, this is not meant to be limiting. Various aspects of the present disclosure that are described as being performed by and/or stored on knowledge system 100 can alternatively be performed by and/or stored elsewhere and/or distributed across multiple systems, such as between system 100 and a client device 110. In various implementations, a user may interact with knowledge system 100 using client device 110.

While shown as separate systems that communicate using network(s) 199, this is not meant to be limiting. Aspects of knowledge system 100 may be implemented in whole or in part on client device 110. If client device 110 includes sufficient computing resources, and/or generative model(s) it uses can be made sufficiently “lean” it may be possible to implement techniques described herein locally on client device 110 to avoid latency introduced by a round trip across network(s) 199. Aspects of the client device 110 can additionally and/or alternatively be implemented in whole or in part by the knowledge system 100.

The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices 110 may be provided. The client device 110 can, in some implementations, include a user input engine 112 and/or a rendering engine 114.

The user input engine 112 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input.

The rendering engine 114 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, content that is in response to a user query and/or confirmation of one or more tasks performed in response to a user query.

Knowledge system 100 may include a context determination engine 122, a prompt determination engine 124, a merger engine 126, and a generative model (GM) output generation engine 128 communicatively coupled with one or more generative models 130. Generative model(s) 130 described herein may take various forms, including, but not limited to, model(s) such as Gemini, Flamingo, PaLM, BERT, LaMDA, Meena, and/or any other single-modal (e.g., large language model or “LLM”) or multimodal generative model, such as any other generative model that is encoder-only based, decoder-only based, sequence-to-sequence based and that optionally includes an attention mechanism or other memory, diffusion model(s), etc. Generative models may have hundreds of millions, hundreds of billions, trillions, or even more parameters. In some implementations, generative models may include multi-modal models such as a vision language model (VLM) and/or a visual question answering (VQA) model, which can have any of the aforementioned architectures, and which can be used to process multiple modalities of data, particularly images and text, and/or images and audio for example, to generate one or more modalities of output. Some generative models trained on Internet-scale (or “web-scale”) data may be referred to as “foundation” models.

The context determination engine 122 can process signals provided by one or more computing devices to determine that one or more users share a context with one or more other users. These signals may include, but are not limited to, a wireless signal (e.g., BLUETOOTH, WI-FI, NFC, cellular signal, etc.) generated by a mobile device carried by one or more of the users, an electronic calendar of one or more of the users, position coordinates of mobile devices carried by the users, electronic correspondence, contemporaneous detection of biometrics (e.g., voice recognition, facial recognition, etc.) of the users, and so forth. In some implementations, the context determination engine 122 may process signals provided by one or more computing devices to determine that one or more devices share a context with one or more other devices, and/or that one or more users share a context with one or more devices and/or other user(s).

The prompt determination engine 124 can determine prompts for one or more users and/or one or more devices. The user prompts and/or device prompts can be used to condition generative model(s) to generate output that accounts for the users' and/or devices' preferences and/or attributes. The user prompts and/or device prompts can be formulated by the prompt determination engine 124 in natural language, structured text, and/or a combination thereof. The prompt determination engine 124 can receive data from multiple sources in determining one or more of the user prompts and/or device prompts. For example, the prompt determination engine 124 can receive data from a user profile, device history, electronic correspondence, and/or other sources.

The merger engine 126 can assemble one or more user prompts, one or more device prompts, and/or other data into a merged input prompt. The other data can include, for example, a natural language query issued by a user to an automated assistant. The merger engine 126 can format the merged input prompt according to the requirements of a generative model. For example, the merger engine 126 can assemble the merged prompt as a natural language statement for a generative model 130 that accepts natural language input. In other implementations, the merger engine 126 can assemble the merged prompt as a structured statement for a generative model 130 that accepts structured inputs.

The generative model output engine 128 can apply an input across one or more generative models 130. For example, the generative model output engine 128 can apply the merged input prompt assembled by the merger engine 126 across one or more generative models to generate content and/or cause one or more actions to be performed in response to a user query.

In some implementations, knowledge system 100 may include one or more computing devices cooperating to perform selected aspects of the present disclosure. In some implementations, knowledge system 100 may include one or more servers forming part of what is often referred to as a “cloud” infrastructure, or simply “the cloud.” Alternatively, one or more components of system 100 may be operated by client device 110.

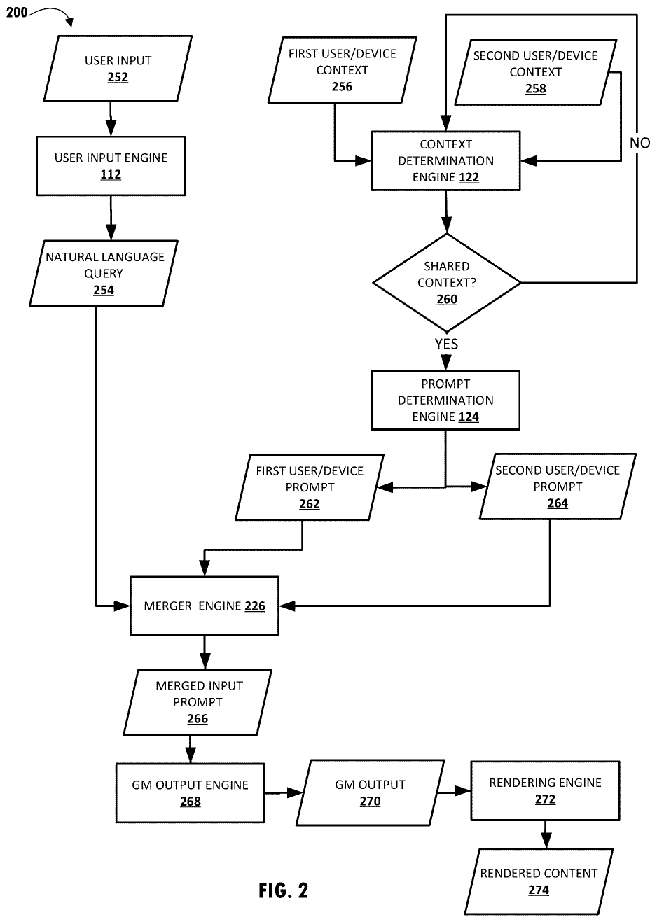

Referring now to FIG. 2, an example process flow 200 for utilizing various components from the example environment of FIG. 1 is depicted.

In various implementations, a user input 252 can be provided to the user input engine 112112. The user input can be, for example, spoken input captured in audio data generated via microphone(s) of the client device 110, typed and/or touch input captured in typed and/or touch data generated via a display or other input device of the client device 110, and/or other inputs (e.g., gesture inputs, etc.). The user input engine 112 can process the user input 252 and determine that the user input 252 corresponds to a natural language query 254. The natural language query 254 can be a request for one or more actions to be performed. For example, the natural language query 254 can be a request for a user device to display particular content, such as “Select a sports program for User 1 and User 2 to watch.” As another example, the natural language query 254 can be a request to complete one or more tasks, such as “Order User 1 and User 2 a pizza.”

The context determination engine 122 can determine whether one or more users and/or one or more devices have a shared context 260. One or more of a first user and/or device context 256 or a second user and/or device context 256, can be applied as input to the context determination engine 122. The first user and/or device context 256 and the second user and/or device context 258 can be determined based on one or more signals provided by one or more computing devices. For example, one or more of the signals can indicate that the first user and/or device and the second user and/or device share a geographic proximity, have a temporal relationship, share a common virtual environment, and/or any other type of shared context.

In some implementations, the context determination engine 122 may determine that the first user and/or device context 256 is not shared with the second user and/or device context 258. In these implementations, one or more signals from one or more computing devices can continue to be processed by the context determination engine 122 to determine (at block 260) whether a shared context develops.

In some implementations, the context determination engine 122 may determine that the first user and/or device context 256 and the second user device and/or context 258 is a shared context 260. In these implementations, a prompt determination engine 124 may determine one or more of a first user and/or device prompt 262 or a second user and/or device prompt 264.

The first user and/or device prompt 262 and the second user and/or device prompt 264 can indicate preferences and/or attributes of a first user/device and/or a second user/device. The preferences and/or attributes of the first user/device and/or the second user/device can be obtained from various electronic resources, such as explicit statement(s) from the user, past queries submitted to automated assistant(s), past search engine queries, digital files created or interacted with by the user, electronic correspondence (e.g., emails, text messages) sent and/or received by the user, social media posts of the user, web browsing history, past online bookings, past travel trajectories, etc. These various electronic resources can be obtained through communications with one or more computing devices, including a first user device operated by a first user (not depicted in FIG. 2), a second user device operated by a second user (not depicted in FIG. 2), a device that received the user input 252, or any other accessible electronic device.

User and device prompts are not limited to textual data. Other modalities of data may be assembled into user and/or device prompts. For example, in some implementations, vision data captured by vision sensors onboard client device 110, and/or audio data captured by microphone(s) onboard client device 110, may be assembled into a user or device prompt, e.g., explicitly by the user and/or automatically (with the user's prior consent). Once merged into the merged input prompt 266 as described below, the vision and/or audio data may condition the generative model to the context represented by the vision and/or audio data. For example, if the user is in a loud environment but carries a client device 110 connected to sound-canceling headphones, that client device 110 may be promoted for playback of audio over another device that lacks sound-canceling capabilities.

In various implementations, the first user and/or device prompt 262, the second user and/or device prompt 264, and the natural language query 254, or data indicative thereof, can be provided as input to the merger engine 126. The merger engine 126 can generate a merged input prompt 266 that is based on one or more of the first user and/or device prompt 262, the second user and/or device prompt 264, or the natural language query 254.

In some implementations, the merged input prompt 266 can be a natural language combination of one or more aspects of the first user and/or device prompt 262, the second user and/or device prompt 264, or the natural language query 254. The merged input prompt 266 may, in some implementations, include structured data that is representative of one or more aspects of the first user and/or device prompt 262, the second user and/or device prompt 264, or the natural language query 254. The merged input prompt 266 can, in some implementations, include information that was not included in the first user and/or device prompt 262, the second user and/or device prompt 264, or the natural language query 254.

The merged input prompt 266, in some implementations, can be applied as input to a generative model by the generative model output engine 268. The generative model output engine 268 can predict, using the generative model, a generative model output 270. The generative model output 270 may be provided as input to the rendering engine 272, which can then cause rendered content 274 that is responsive to the natural language query 254 to be presented. While examples here relate to textual output and automated playback of content, this is not meant to be limiting.

In some implementations, the rendered content 274 can be a natural language response to the natural language query 254. The natural language response may have been conditioned based on or more of the first user and/or device prompt 262 or the second user and/or device prompt 264.

In various implementations, the generative model output 270 can be instructions that cause one or more actions to be performed. The rendered content 274 can be confirmation that one or more of the actions were performed in response to the natural language query 254. In some implementations, the rendered content 274 can be one or more of the actions to be performed in response to the natural language query 254. The generative model output 270 can cause that particular rendered content 274 to be rendered. The generative model output 270 can include instructions to cause the rendered content 274 to be rendered at a particular device, at a particular time, at a particular location, and/or when a particular user is determined to be present.

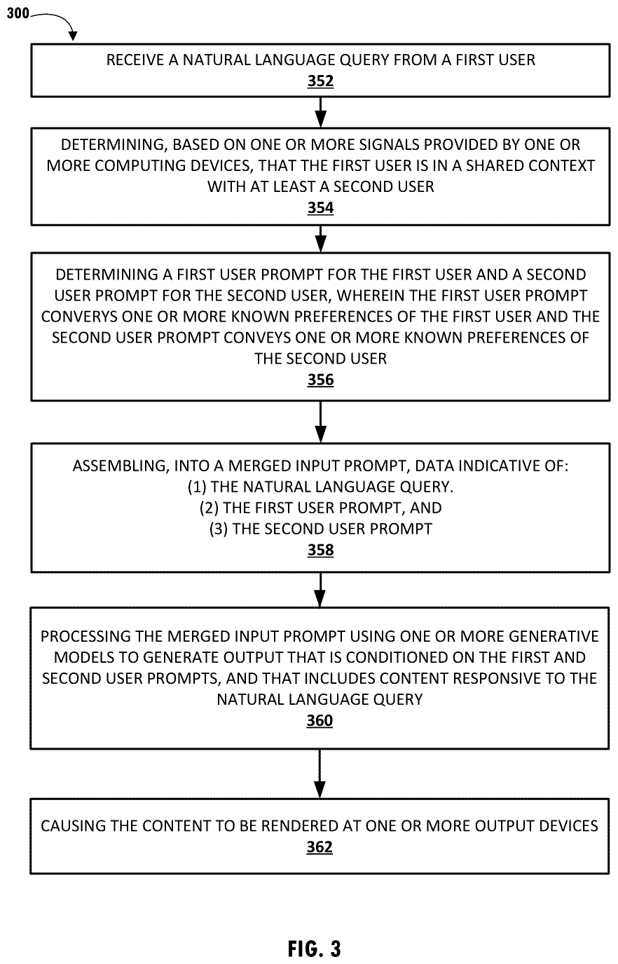

FIG. 3 depicts a flowchart illustrating an example method of merging generative model prompts based on user preference. For convenience, the operations of the method 300 are described with reference to a system that performs the operations. The system of method 300 includes at least one processor, memory, and/or other component(s) of computing device(s) (e.g., client device 110 and/or knowledge system 100 of FIG. 1 and/or other computing devices). Moreover, while the operations of the method 300 are shown in a particular order, this is not meant to be limiting. One or more operations may be reordered, omitted, and/or added.

At block 352, the system, e.g., by way of user input engine 112, receives a natural language query 254 from a first user. For example, the system can receive the natural language query 254 as a result of a textual and/or audible input at a user device. For example, the user may interact with a graphical user interface to provide a textual user input 252. The user may also provide an audible user input 252 via one or more microphones of a user device.

At block 354, the system, e.g., by way of context determination engine 122, can determine, based on one or more signals provided by one or more computing devices, that the first user is in a shared context with at least a second user (similar to block 260 of FIG. 2). The signals may include, but are not limited to, a wireless signal (e.g., BLUETOOTH, WI-FI, NFC, cellular signal, etc.) generated by a mobile device carried by one or more of the users, an electronic calendar of one or more of the users, position coordinates of mobile devices carried by the users, contemporaneous detection of biometrics (e.g., voice recognition, facial recognition, etc.) of the users, and so forth.

The shared context, in some implementations, can be that the first user and the second user share one or more physical aspects of an environment, such as location. For example, a wireless signal generated by a mobile device of the first user and a wireless signal generated by a mobile device of the second user can indicate that the distance from the first user to the second user satisfies a threshold distance.

Alternatively and/or additionally, the shared context can be that the first user and the second user have a similar temporal constraint, such as a meeting at a similar time. The shared context 260 can also be that biometrics of the first user and the second user are recognized at a similar time and location. For example, an assistant device can verify that the first user and the second user have been detected speaking at or around the assistant device via voice and/or facial recognition.

In other implementations, the shared context can be that the first user and the second user share one or more virtual environments. For example the first user and the second user can both be participants in a message thread, have interacting social media pages, can both be participants in a video call, etc.

At block 356, the system, e.g., by way of prompt determination engine 124, can determine a first user prompt 262 for the first user and a second user prompt 264 for the second user. The first user prompt 262 can convey one or more known preferences of the first user and the second user prompt 264 can convey one or more known preferences of the second user.

The first user prompt 262 and the second user prompt 264 can be determined based on data received from one or more electronic sources. In some implementations, the data used to determine the first user prompt 262 and/or the second user prompt 264 can be received from personal computing devices of the first user and/or the second user. In various implementations, the data can be communicated with the system via one or more networks 199, and can be received from one or more third party computing devices.

For example, data indicative of explicit statement(s) from the user, past queries submitted to automated assistant(s), past search engine queries, digital files created or interacted with by the user, electronic correspondence (e.g., emails, text messages) sent and/or received by the user, social media posts of the user, web browsing history, past online bookings, past travel trajectories, etc., can be used in determining the first user prompt 262 and/or the second user prompt 264.

At block 358, the system, e.g., by way of merger engine 126, can assemble, into a merged input prompt 266, data indicative of the natural language query 254, the first user prompt 262, and the second user prompt 264. In various implementations, the merged input prompt 266 can be a natural language representation of one or more aspects of the natural language query 254, the first user prompt 262, and the second user prompt 264. In some implementations, the merged input prompt 266 can be a structured data representation of one or more aspects of the natural language query 254, the first user prompt 262, and the second user prompt 264. In yet other implementations, the merged input prompt 266 can be a combination of natural language representations of one or more aspects of the natural language query 254, the first user prompt 262, and the second user prompt 264 and structured data representations of one or more aspects of the natural language query 254, the first user prompt 262, and the second user prompt 264. If any user and/or device prompt, or a user query, includes other modalities of data, such as images, audio, etc., then those content (or embeddings generated therefrom) may be included in the merged input prompt 266 as well.

Additionally or alternatively, in some implementations, a generative model may be used to generate a summary of the first user prompt 262 and/or the second user prompt 264 to some target length constraint (e.g., number of tokens, number of words, number of sentences, number of clauses, etc.).

In some implementations, the first user prompt 262 and/or the second user prompt 264 can be weighted prior to the merged input prompt 266 being assembled. The weights of the first user prompt 262 and the second user prompt 264 can be determined, for example, based on the relative proximity of the first user and/or the second user to an audio and/or vision sensor of the computing device. The computing device can be the user device that received user input, a different computing device, or a combination of both.

Alternatively and/or additionally, the first user prompt 262 and/or the second user prompt 264 can be weighted based on the user that issued the natural language query 254. The identity of the user can be determined based on voice recognition, facial recognition, active user profiles, user distance from a visual and/or audio sensor of a computing device, etc. For example, a first user can be determined to have issued the natural language query 254, therefore the first user prompt 262 can be assigned greater weight than the second user prompt 264.

In various implementations, weighting of the first user prompt 262 and/or the second user prompt 264 can result in allocating different numbers of tokens of the merged input prompt 266 to different user prompts. For example, if the first user prompt 262 is assigned more weight than the second user prompt 264, more tokens of the merged input prompt 266 may be allocated to the first user prompt 262 than to the second user prompt 264.

In other implementations, the weights may be used as and/or to determine relative priorities to be assigned to known preferences and/or attributes conveyed in the first user prompt 262 and/or the second user prompt 264. These relative priorities may then be assembled into the merged input prompt 266 to condition the generative model's output accordingly. For example, if two different users have conflicting food preferences, the first user prompt 262, if assigned a greater weight (e.g., because he/she issued the natural language query 254 to the automated assistant), may have a higher priority assigned to their preference, which may result in the second user's preference being demoted or ignored.

At block 360, the system, e.g., by way of generative model output engine 268, can process the merged input prompt 266 using one or more generative models to generate generative model output 270 that is conditioned on the first user prompt 262 and/or the second user prompt 264 and that is responsive to the natural language query 254. For example, in response to a natural language query 254 of “Order a pizza for user 1 and user 2”, the generative model output engine 268 can generate a confirmation that a pizza was ordered that conforms to the preferences of user 1 and user 2.

In some implementations, the generative model output 270 can be a direct response to the natural language query 254. For example, a natural language query 254 of “What genre of music should user 1 and user 2 listen to?” can cause the generative model output 270 to be “Country Music” when the first user prompt 262 and the second user prompt 264 indicate that both the first user and the second user share a preference for country music.

In some implementations, the generative model output 270 can be instructions that cause one or more actions to be performed or for particular content to be rendered. For example, a natural language query of 254 “Play music for user 1 and user 2” can cause the generative model output 270 to be instructions that cause an automated assistant to play country music over a speaker of a computing device. Alternatively and/or additionally, in some implementations, a natural language query 254 does not need to specify the users and/or devices that are present. For example, the relevant users and/or devices can be determined, for example, based on location data associated with a device of a user, biometric data such as facial and/or voice recognition, user profiles assigned to a particular device, and/or any other means of identifying relevant users and/or devices.

At block 362, the system, e.g., by way of knowledge system 100 and/or rendering engine 272, can cause rendered content 274 to be rendered via one or more output devices that is responsive to the natural language query 254 and is conditioned one the first user prompt 262 and/or the second user prompt 264. The rendered content 274 can be, for example, a textual output that is rendered at a display of a client device, an audible output that is rendered via one or more speakers of a client device, and/or a haptic output that is rendered via the client device.

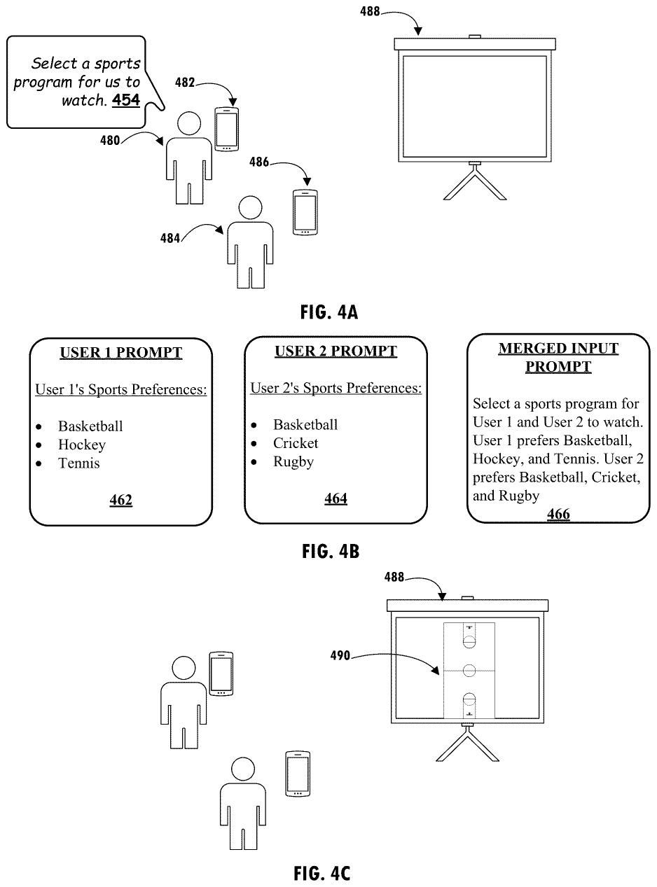

Turning now to FIGS. 4A, 4B, and 4C an example scenario in which a natural language query 454 is fulfilled using a merged input prompt 466 that is conditioned with a user 1 prompt 462 and a user 2 prompt 464 is depicted schematically. For this example scenario, assume user 1 480 and user 2 484 want to watch a sports program, but each user has their own set of preferences about which program to watch. User 1 480 can provide the following natural language query 454 to a user 1 device 482: “Select a sports program for us to watch”. Location data from the user 1 device 482 and a user 2 device 486 can be utilized to determine that user 1 480 and user 2 486 are in a shared context based on their geographic proximity to one another.

In some implementations, based on the determination that user 1 480 and user 2 484 are in a shared context, a user 1 prompt 462 and a user 2 prompt 464 can be obtained. The user 1 prompt 462, in this example, indicates that that user 1 480 prefers to watch basketball, hockey, and tennis. The user 2 prompt 464, in this example, indicates that user 2 484 prefers to watch basketball, cricket, and rugby.

Continuing the example, the user 1 prompt 462, the user 2 prompt 464, and the natural language query 454 can be assembled into a merged input prompt 466. The merged input prompt 466 can include elements from the user 1 prompt 462, the user 2 prompt 464, and the natural language query 454. Additionally, the merged input prompt 466 need not be an exact translation of the user 1 prompt 462, the user 2 prompt 464, and/or the natural language query 454. The different elements of the user 1 prompt 462, the user 2 prompt 464, and/or the natural language query 454 can be formatted to from an appropriate merged input prompt 466. For example, the natural language query 454 of “Select a sports program for us to watch” has been changed in the merged input prompt 466 to “Select a sports program for User 1 and User 2 to watch.”

In various implementations, the merged input prompt 466 can be applied to a generative model which results in one or more actions being performed and/or content to be rendered via a computing device. In the depicted example, the merged input prompt 466 can be applied to a generative model, which results in a basketball game 490 being rendered via a television 488. The basketball game 490 is rendered responsive to the natural language query 454 because the natural language query 454 has been conditioned based on the user 1 prompt 462 and the user 2 prompt 464, which indicate that both user 1 480 and user 2 484 have a common preference for watching a basketball game 490 when watching a sports program.

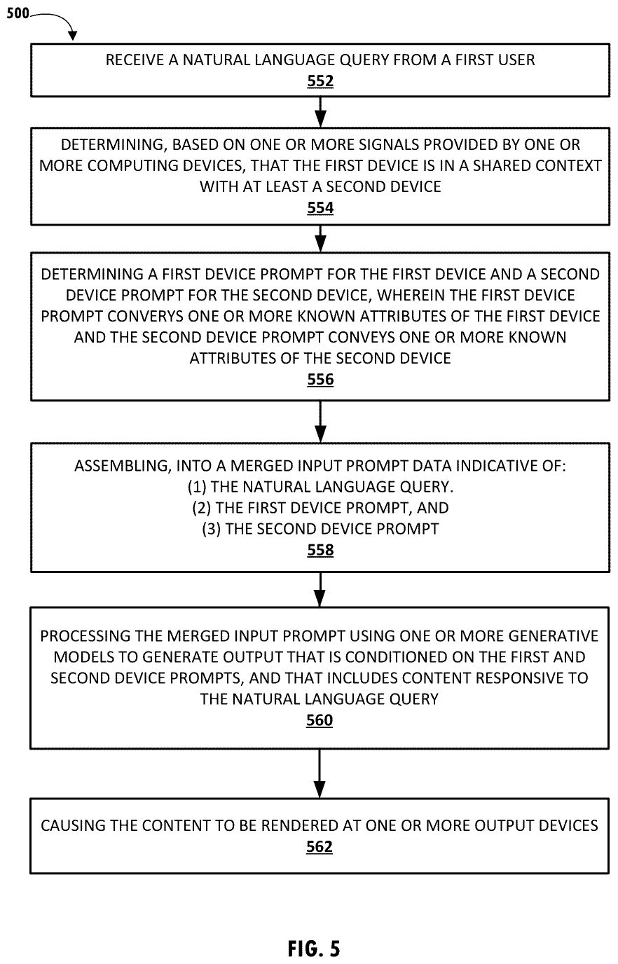

FIG. 5 depicts a flowchart illustrating an example method of merging LLM prompts based on device preference. For convenience, the operations of the method 500 are described with reference to a system that performs the operations. The system of method 500 includes at least one processor, memory, and/or other component(s) of computing device(s) (e.g., client device 110 and/or knowledge system 100 of FIG. 1 and/or other computing devices). Moreover, while the operations of the method 500 are shown in a particular order, this is not meant to be limiting. One or more operations may be reordered, omitted, and/or added.

At block 552, the system, e.g., by way of user input engine 112, receives a natural language query 254 from a first user. For example, the system can receive the natural language query 254 as a result of a textual and/or audible input at a user device. For example, the user may interact with a graphical user interface to provide a textual user input 252. The user may also provide an audible user input 252 via one or more microphones of a user device.

At block 554, the system, e.g., by way of context determination engine 122, can determine, based on one or more signals provided by one or more computing devices, that the first device is in a shared context 260 with at least a second device. The signals may include, but are not limited to, a wireless signal (e.g., BLUETOOTH, WI-FI, NFC, cellular signal, etc.) generated by, the first device, the second device, and/or a mobile device carried by one or more of the users, an electronic calendar of one or more of the users, position coordinates of mobile devices carried by the users, contemporaneous detection of biometrics (e.g., voice recognition, facial recognition, etc.) of the users, and so forth.

The shared context 260, in some implementations, can be that the first device and the second device share one or more physical aspects of an environment, such as location. For example, a wireless signal generated by the first device and/or a wireless signal generated by the second device can indicate that the distance between the first device and the second device satisfies a threshold distance, and/or that both are on the same WI-FI or cellular network. As another example, visual and/or audio sensor data from the first device, the second device, and/or another computing device can indicate a distance of a user from the first device and/or the second device. The shared context 260, can be that the user is within a threshold distance of the first device and/or the second device.

Alternatively and/or additionally, the shared context 260 can be based on hardware and/or software capabilities of the first user device and the second user device. For example, both the first user device and the second user device having the capability to render audible and/or visual content can be a shared context 260. As another example, both the first device and the second device having internet access can be a shared context 260.

At block 556, the system, e.g., by way of prompt determination engine 124, can determine a first device prompt 262 for the first device and a second device prompt 264 for the second device. The first device prompt 262 can convey one or more known preferences of a user with respect to how the first device is used and/or one or more hardware and/or software capabilities of the first device. The second device prompt 264 can convey one or more known preferences of a user with respect to how the second device is used and/or one or more hardware and/or software capabilities of the second device.

The first device prompt 262 and the second device prompt 264 can be determined based on data received from one or more electronic sources. In some implementations, the data used to determine the first device prompt 262 and/or the second device prompt 264 can be received from personal computing devices of a user. In various implementations, the data can be communicated with the system via one or more networks 199, and can be received from one or more third party computing devices.

For example, data indicative of explicit statement(s) from a user, past queries submitted to automated assistant(s), past search engine queries, digital files created or interacted with by the user, electronic correspondence (e.g., emails, text messages) sent and/or received by the user, social media posts of the user, web browsing history, past online bookings, past travel trajectories, etc., can be used in determining the first device prompt 262 and/or the second device prompt 264.

As another example, historical use information can be used in determining the first device prompt and/or the second device prompt. For example, if a user historically uses a first device to play music, and a second device to watch television, then those preferences can be determined in the first and second device prompts. Additionally, and/or alternatively, manufacturer information can be stored on device and/or on the web and accessed by the system in determining the first device prompt and/or the second device prompt.

At block 558, the system, e.g., by way of merger engine 126, can assemble, into a merged input prompt 266, data indicative of the natural language query 254, the first device prompt 262, and the second device prompt 264. In various implementations, the merged input prompt 266 can be a natural language representation of one or more aspects of the natural language query 254, the first device prompt 262, and the second device prompt 264. In some implementations, the merged input prompt 266 can be a structured data representation of one or more aspects of the natural language query 254, the first device prompt 262, and the second device prompt 264. In yet other implementations, the merged input prompt 266 can be a combination of natural language representations of one or more aspects of the natural language query 254, the first device prompt 262, and the second device prompt 264 and structured data representations of one or more aspects of the natural language query 254, the first device prompt 262, and the second device prompt 264.

Additionally or alternatively, in some implementations, a generative model may be used to generate a summary of the first device prompt 262 and/or the second device prompt 264 to some target length constraint (e.g., number of tokens, number of words, number of sentences, number of clauses, etc.).

In some implementations, the first device prompt 262 and/or the second device prompt 264 can be weighted prior to the merged input prompt 266 being assembled. The weights of the first device prompt 262 and the second device prompt 264 can be determined, for example, based on the relative proximity of the first device and/or the second device to a user. The relative proximity of the user can be determined based on data from an audio and/or vision sensor of the first device and/or the second device.

Alternatively and/or additionally, the first device prompt 262 and/or the second device prompt 264 can be weighted based on the user that issued the natural language query 254. The identity of the user can be determined based on voice recognition, facial recognition, active user profiles, user distance from a visual and/or audio sensor of a computing device, etc. For example, a first user can be determined to have issued the natural language query 254, therefore the first device prompt 262 can be weighted more than the second device prompt 264 based on a user preference for the first device over the second device.

In various implementations, weighting of the first device prompt 262 and/or the second device prompt 264 can be implemented by allocating different numbers of tokens of the merged input prompt 266 to different device prompts. For example, if the first device prompt 262 is assigned more weight than the second device prompt 264, more tokens of the merged input prompt 266 may be allocated to the first device prompt 262 than to the second device prompt 264.

In other implementations, the weights may be used as and/or to determine relative priorities to be assigned to known preferences and/or attributes conveyed in the first device prompt 262 and/or the second device prompt 264. These relative priorities may then be assembled into the merged input prompt 266 to condition the generative model's output accordingly. For example, if two different devices have similar attributes, the first device prompt 262, if assigned a greater weight (e.g., because the first device is nearest to the user who issued the natural language query 254 to the automated assistant), may have a higher priority assigned to it's preference, which may result in the second device's preference being demoted or ignored.

At block 560, the system, e.g., by way of generative model output engine 268, can process the merged input prompt 266 using one or more generative models to generate generative model output 270 that is conditioned on the first device prompt 262 and/or the second device prompt 264 and that is response to the natural language query 254. For example, in response to a natural language query of “Play my fun music playlist”, the generative model output engine 268 can generate instructions that cause music to be played from a device according the user's preferences and/or the device's capabilities.

While textual content and media are described herein as responsive content generated using merged generative model prompts, other modalities of content can be generated as well. For example, techniques described herein may facilitate cooperation between multiple team members in generating group content. For example, multiple coworkers could use techniques described herein to generate documents such as slide decks, spreadsheets, synthetic images, synthetic videos, synthetic audio, etc.

Techniques described herein may also facilitate control of smart appliances in a household. For example, if one household member requests a particular lighting scene (e.g., “relaxing”) be implemented, one user prompt may be generated for the requesting household member, another user prompt may be generated for a roommate that is also present, and one or more device prompts may be generated for particular smart light bulbs, smart shades, etc., describing their capabilities vis-à-vis the requested scene. These various user and device prompts may be merged into a merged prompt and processed using a generative model. The output may include settings for individual lights that will satisfy the preferences of the multiple members of the household, as well as any constraints associated with the devices. For example, suppose one roommate issues the request, “turn off all the lights,” without realizing that a second roommate is still reading a book. The second roommate's user prompt and/or a device prompt for the second roommate's reading light may suggest that this reading light should not be turned off. Consequently, when the first roommate issues the request, the merged prompt may indicate that all lights other than the reading light should be extinguished.

At block 562, the system, e.g., by way of knowledge system 100 and/or rendering engine 272, can cause rendered content 274 to be rendered via one or more output devices that is responsive to the natural language query 254 and is conditioned one the first device prompt 262 and/or the second device prompt 264. The rendered content 274 can be, for example, a textual output that is rendered at a display of a phone, an audible output that is rendered via one or more speakers of a client device, a visual output that is rendered at a display of a television, and/or a haptic output that is rendered via the client device.

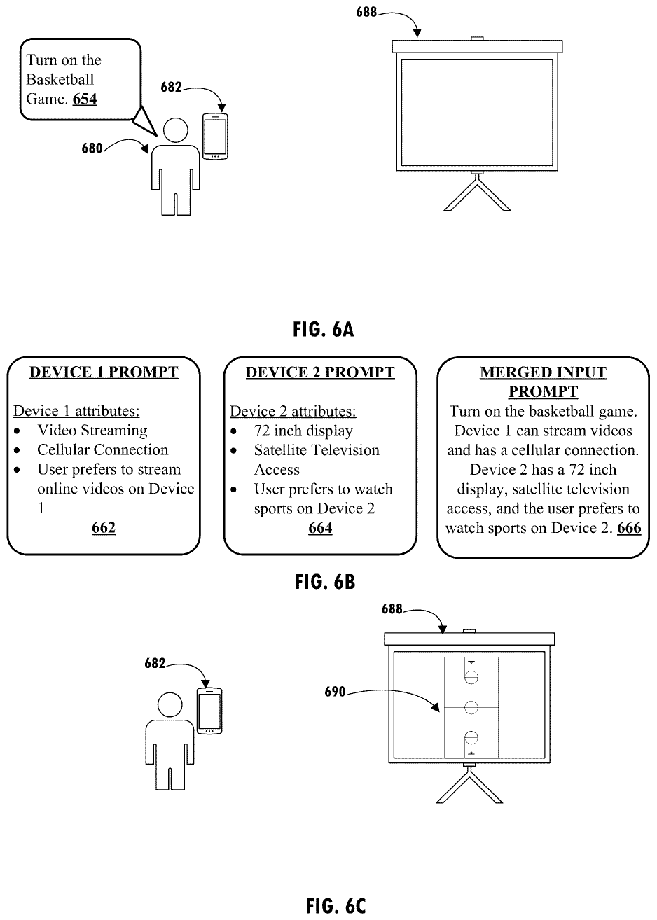

Turning now to FIGS. 6A, 6B, and 6C an example scenario in which a natural language query 654 is fulfilled using a merged input prompt 666 that is conditioned with a device 1 prompt 662 and a device 2 prompt 664 is depicted schematically. For this example scenario, assume a user 680 wants to watch a basketball game, but both device 1 682 and device 2 are capable of rendering visual content. The user 680 can provide the following natural language query 654: “Turn on the Basketball Game”, without specifying which device to render the content. Sensor data from the device 1 682 and device 2 688 can be utilized to determine that device 1 682 and device 2 688 are in a shared context based on their geographic proximity to the user 680 who issued the natural language query 654.

In some implementations, based on the determination that device 1 682 and device 2 688 are in a shared context, a device 1 prompt 662 and a device 2 prompt 664 can be obtained. The device 1 prompt 662, in this example, indicates that device 1 can stream videos, has a cellular connection, and that a user 680 prefers to watch online videos on device 1. The device 2 prompt 664, in this example, indicates that device 2 has a 72 in display, satellite television access, and that the user 680 prefers to watch sports on device 2.

Continuing the example, the device 1 prompt 662, the device 2 prompt 664, and the natural language query 654 can be assembled into a merged input prompt 666. The merged input prompt 666 can include elements from the device 1 prompt 662, the device 2 prompt 664, and the natural language query 654. Additionally, the merged input prompt 666 need not be an exact translation of the device 1 prompt 662, the device 2 prompt 664, and/or the natural language query 654. The different elements of the device 1 prompt 662, the device 2 prompt 664, and/or the natural language query 654 can be formatted to form an appropriate merged input prompt 666. For example, the merged input prompt 666 states “Device 1 can stream videos and has a cellular connection” instead of the bulleted list of the device 1 prompt 662.

In various implementations, the merged input prompt 666 can be applied to a generative model which results in one or more actions being performed and/or content to be rendered via a computing device. In the depicted example, the merged input prompt 666 can be applied to a generative model, which results in a basketball game 690 being rendered via device 2 688. The basketball game 690 is rendered responsive to the natural language query 654 because the natural language query 654 has been conditioned based on the device 1 prompt 662 and the device 2 prompt 664, which indicate that the user 680 prefers streaming videos on device 1 682, while the user 680 prefers watching sports on device 2 688. Although both device 1 682 and device 2 688 may both be capable of streaming the basketball game 690, the device preference communicated in device prompt 2 664 of watching sports on device 2 causes the basketball game 690 to be rendered via device 2 688.

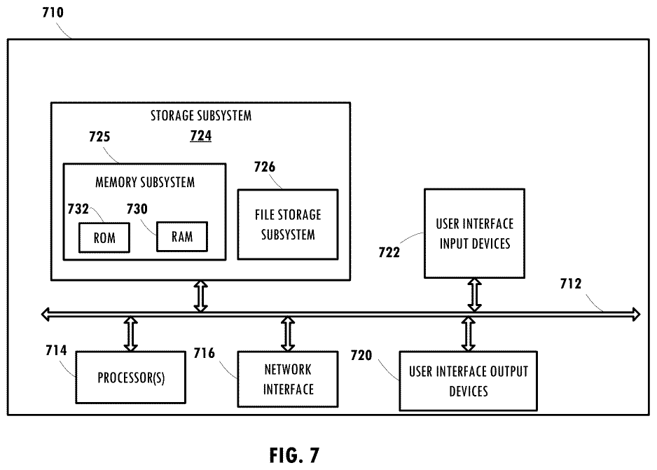

FIG. 7 is a block diagram of an example computer system 710. Computer system 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein. For example, the storage subsystem 724 may include the logic to perform selected aspects of methods 200, and/or to implement one or more aspects of the various components depicted in FIG. 1. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a CD-ROM drive, an optical drive, or removable media cartridges. Modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computer system 710 communicate with each other as intended. Although bus subsystem 712 is shown schematically as a single bus, alternative implementations of the bus subsystem may use multiple buses.

Computer system 710 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 710 depicted in FIG. 7 is intended only as a specific example for purposes of illustrating some implementations. Many other configurations of computer system 710 are possible having more or fewer components than the computer system depicted in FIG. 7

In one aspect, a method may be implemented using one or more processors and may include: receiving a natural language query from a first user; determining, based on one or more signals provided by one or more computing devices, that the first user is in a shared context with at least a second user; determining a first user prompt for the first user and a second user prompt for the second user, wherein the first user prompt conveys one or more known preferences of the first user and the second user prompt conveys one or more known preferences of the second user; assembling, into a merged input prompt, data indicative of: the natural language query, the first user prompt, and the second user prompt; processing the merged input prompt using one or more generative models to generate output that is conditioned on the first and second user prompts, and that includes content responsive to the natural language query and; and causing the content to be rendered at one or more output devices.

In some implementations, the shared context can include a shared physical environment. The one or more signals can include a wireless signal generated by a mobile device carried by the first or second user. Alternatively and/or additionally the one or more signals can include contemporaneous detection of one or more biometrics of the first user and one or biometrics of the second user.

In various implementations, the shared context can include a multi-participant message exchange thread in which the first and second users are participants. The multi-participant message exchange thread can include a text messaging thread. In some implementations, the first user prompt can include one or more natural language statements that convey one or more of the known preferences of the first user.

The method can further include retrieving one or more digital files created or interacted with by the first user; assembling, into a user preference generation prompt, data indicative of or derived from the one or more digital files; and processing the user preference generation prompt using one or more of the generative models to generate data indicative of the first user prompt. In some implementations, one or more of the digital files can include one or more of a digital image, digital audio, or digital video.

In various implementations, the method can include assembling, into a user preference generation prompt, data indicative of or derived from one or more past natural language queries issued by the first user; and processing the user preference generation prompt using one or more of the generative models to generate data indicative of the first user prompt.

Additionally and/or alternatively, the method can include assembling, into a user preference generation prompt, data indicative of or derived from one or more past search engine queries issued by the first user; and processing the user preference generation prompt using one or more of the generative models to generate data indicative of the first user prompt.

In various implementations, the method can include determining one or more device prompts for one or more computing devices available in the shared context, wherein the one or more device prompts convey one or more attributes of the one or more computing devices available in the shared context; and assembling, into the merged input prompt, data indicative of the one or more device prompts.

In some implementations, the one or more attributes can include one or more of: one or more preferences for operating one or more of the computing devices available in the shared context to render content; one or more states of one or more sensors of one or more of the computing devices available in the shared context; or one or more resource constraints of one or more of the computing devices available in the shared context.

In various implementations, the method can include determining respective weights for the first and second user prompts, wherein the assembling is based on the respective weights. The respective weights for the first and second user prompts can be determined based on relative proximities of the first and second users to a shared audio or vision sensor. The respective weights for the first and second user prompts can, alternatively and/or additionally be determined based on which of the first or second user issued the natural language query.

In some implementations, the assembling can include allocating different numbers of tokens to each of the first and second user prompts based on the respective weights. The assembling can include, in various implementations, assembling, into a summarization input prompt, data indicative of the first user prompt and a target length constraint, wherein the target length constraint is selected based on one or more of the respective weights for the first and second user input prompts; and processing the summarization input prompt using one or more of the generative models to generate a summary of the first user prompt that satisfies the target length constraint.

In various implementations, the method can include assembling, into the merged input prompt, data indicative of relative priorities to be assigned to known preferences conveyed in the first and second user prompts, wherein the relative priorities are determined based on the respective weights.

In various implementations, the assembling can include: assembling, as a prompt merging input prompt, data indicative of: the first and second user prompts, and a request to combine the first and second user prompts into the merged input prompt while resolving any conflicts between the first and second user prompts; and processing the prompt merging input prompt using one or more of the generative models to generate at least a portion of the merged input prompt.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method implemented using one or more processors, comprising:
receiving a natural language query;
determining, based on one or more signals provided by one or more computing devices, that a first user is in a shared context with at least a second user;
determining which user, of the first user and the second user, provided the natural language query;
determining a first user prompt for the first user and a second user prompt for the second user, wherein the first user prompt conveys one or more known preferences of the first user and the second user prompt conveys one or more known preferences of the second user;
determining, based on determining which user, of the first user and the second user, provided the natural language query, one or more weights for the first user prompt and/or the second user prompt;
assembling, based on the one or more of the weights for the first user prompt and/or the second user prompt, into a merged input prompt, data indicative of:
the natural language query,
the first user prompt, and
the second user prompt;
processing the merged input prompt using one or more generative models to generate output that is conditioned on the first and second user prompts, and that includes content responsive to the natural language query; and
causing the content to be rendered at one or more output devices.

2. The method of claim 1, wherein the shared context comprises a shared physical environment.

3. The method of claim 2, wherein the one or more signals comprise a wireless signal generated by a mobile device carried by the first or second user.

4. The method of claim 2, wherein the one or more signals comprise contemporaneous detection of one or more biometrics of the first user and one or biometrics of the second user.

5. The method of claim 1, wherein the shared context comprises a multi-participant message exchange thread in which the first and second users are participants.

6. The method of claim 5, wherein the multi-participant message exchange thread comprises a text messaging thread.

7. The method of claim 1, wherein the first user prompt comprises one or more natural language statements that convey one or more of the known preferences of the first user.

8. The method of claim 1, further comprising:
retrieving one or more digital files created or interacted with by the first user;
assembling, into a user preference generation prompt, data indicative of or derived from the one or more digital files; and
processing the user preference generation prompt using one or more of the generative models to generate data indicative of the first user prompt.

9. The method of claim 8, wherein one or more of the digital files comprises a digital image, digital audio, or digital video.

10. The method of claim 1, further comprising:
assembling, into a user preference generation prompt, data indicative of or derived from one or more past natural language queries issued by the first user; and
processing the user preference generation prompt using one or more of the generative models to generate data indicative of the first user prompt.

11. The method of claim 1, further comprising:
assembling, into a user preference generation prompt, data indicative of or derived from one or more past search engine queries issued by the first user; and
processing the user preference generation prompt using one or more of the generative models to generate data indicative of the first user prompt.

12. The method of claim 1, further comprising:
determining one or more device prompts for one or more computing devices available in the shared context, wherein the one or more device prompts convey one or more attributes of the one or more computing devices available in the shared context; and
assembling, into the merged input prompt, data indicative of the one or more device prompts.

13. The method of claim 12, wherein the one or more attributes comprise one or more of:
one or more preferences for operating one or more of the computing devices available in the shared context to render content;
one or more states of one or more sensors of one or more of the computing devices available in the shared context; or
one or more resource constraints of one or more of the computing devices available in the shared context.

14. The method of claim 1, further comprising determining respective weights for the first and second user prompts, wherein the assembling is based on the respective weights.

15. The method of claim 14, wherein the respective weights for the first and second user prompts are determined based on relative proximities of the first and second users to a shared audio or vision sensor.

16. The method of claim 15, wherein the respective weights for the first and second user prompts are determined based on which of the first or second user issued the natural language query.

17. The method of claim 16, wherein the assembling comprises allocating different numbers of tokens to each of the first and second user prompts based on the respective weights.

18. The method of claim 17, wherein the assembling comprises:
assembling, into a summarization input prompt, data indicative of the first user prompt and a target length constraint, wherein the target length constraint is selected based on one or more of the respective weights for the first and second user input prompts; and
processing the summarization input prompt using one or more of the generative models to generate a summary of the first user prompt that satisfies the target length constraint.

19. The method of claim 14, further comprising assembling, into the merged input prompt, data indicative of relative priorities to be assigned to known preferences conveyed in the first and second user prompts, wherein the relative priorities are determined based on the respective weights.

20. The method of claim 1, wherein the assembling comprises:
assembling, as a prompt merging input prompt, data indicative of:
the first and second user prompts, and
a request to combine the first and second user prompts into the merged input prompt while resolving any conflicts between the first and second user prompts; and
processing the prompt merging input prompt using one or more of the generative models to generate at least a portion of the merged input prompt.
